(19) United States
(12) Patent Application Publication
(10) Pub. No.: US 2018/0169777 A1
(43) Pub. Date: Jun. 21, 2018

(54) CUTTING BLADE AND METHOD FOR ITS MANUFACTURE

(71) Applicant: Weber Maschinenbau GmbH Breidenbach, Breidenbach (DE)

(72) Inventors: Philip Kahl, Frankenberg (DE); Michael Knauf, Amöneburg (DE); Andreas Runkel, Biedenkopf (DE); Thorsten Schneider, Weimar (DE)

(73) Assignee: Weber Maschinenbau GmbH Breidenbach, Breidenbach (DE)

(21) Appl. No.: 15/839,427

(22) Filed: Dec. 12, 2017

(30) Foreign Application Priority Data
Dec. 16, 2016 (DE) 102016124725.1
Apr. 25, 2017 (DE) 102017108841.5

(51) Int. Cl. B23D 61/02; B26D 1/14; B23D 61/12

(52) U.S. Cl. CPC B23D 61/021; B26D 1/14; B26D 2001/0093; B26D 2210/02; B23D 61/126

(57) ABSTRACT

The invention relates to a cutting blade, in particular to a scythe-like blade or to a spiral blade, for an apparatus for slicing food products, in particular for a high-speed slicer, the cutting blade rotating about an axis of rotation during a cutting operation, having a radially outer peripheral edge which acts as a blade edge and which has a curved extent about the axis of rotation; and having a plurality of cutting teeth which are arranged distributed following one another along the peripheral edge, wherein each cutting tooth has a blade edge which comprises a cutting surface and a cutting edge radially outwardly bounding the cutting surface; wherein each cutting surface extends inclined with respect to a spanned plane perpendicular to the axis of rotation and/or with respect to a cutting plane; and wherein the inclination of the cutting surfaces varies along the peripheral edge.

### BACKGROUND

The invention relates to a cutting blade, in particular to a scythe-like blade or to a spiral blade or to a circular blade, for an apparatus for slicing food products, in particular for a high-speed slicer, the cutting blade rotating about an axis of rotation during a cutting operation. The blade has a radially outer peripheral edge which acts as a blade edge and which has a curved extent about the axis of rotation. The cutting blade furthermore has a plurality of cutting teeth which are arranged distributed following one another along the peripheral edge, wherein each cutting tooth has a blade edge which comprises a cutting surface and a cutting edge radially outwardly bounding the cutting surface.

Cutting blades by which food products such as in particular sausage, cheese and meat are cut into slices or pieces are known in a variety of embodiments. A general distinction between so-called circular blades, on the one hand, and so-called scythe-like blades or spiral blades (in the following simply “scythe-like blades”), on the other hand, is in particular made in the field of high-speed slicers with which high cutting speeds of several hundred to some thousand slices per minute are cut off from a bar-like or loaf-like food product.

Circular blades have a blade edge extending in the form of a circle about the axis of rotation, wherein a circular blade not only carries out a rotation about the axis of rotation, but additionally revolves in a planetary motion about an axis extending eccentrically to, i.e. extending offset in parallel with, the axis of rotation to generate the cutting movement relative to the product required for cutting off slices.

Scythe-like blades have a blade edge which likewise has a curved extent about the axis of rotation, wherein the radius of the blade edge, however, varies between a minimum radius and a maximum radius such that the blade edge describes a scythe-like or spiral curve. Scythe-like blades only rotate about their axis of rotation, wherein the extent of the blade edge differing from a circular shape here ensures the required cutting movement relative to the product. The intended direction of rotation of scythe-like blades is selected such that the blade dips into the product at a starting peripheral region of the blade edge which has a relatively small radius and which is also called a dipping region, wherein the actual cutting movement for cutting off a slice or a piece from a product takes place in that the radius increases on a further rotation of the blade and the blade edge is consequently moved through the product. In this connection, one also speaks of a “pulling through” of the blade edge through the product or of a “pulling cut”.

The term “radius” for a path intersecting the axis of rotation of the blade in a perpendicular manner and which is here not used in a strictly mathematical sense for scythe-like blades has to be distinguished from the term “radius of curvature”. In accordance with the typical convention for defining a tangent at a specific point of a planar curve which is not a circle, the radius of curvature is the contact radius of the circle of curvature which best approximates the curve at this point. The tangent of the curve at this point is perpendicular to the contact radius of this point. With a scythe-like blade, which consequently has a non-circular blade edge, the center of the circle of curvature does not or at least does not necessarily lie on the axis of rotation of the blade.

Since, in a scythe-like blade, the radius, on the one hand, and the radius of curvature, on the other hand, consequently do not coincide for a specific point on the blade edge, the tangent perpendicular to the radius of curvature at this point does not coincide with the movement vector of this point when the blade rotates. Since each point on the cutting edge rotates about the axis of rotation of the blade, the movement vector of each point is perpendicular to the respective radius, but not to the respective radius of curvature.

Whereas, for a specific point on the blade edge, the radius and the radius of curvature and thus the tangent at this point and the movement vector of this point are respectively only identical in a circular blade, it depends on the specific embodiment of a scythe-like blade whether the radius and the radius of curvature or the tangent and the movement vector can respectively be viewed as approximately similar or not for a property of the blade which has just been considered.

In the following, for a specific point on the edge of the blade, the term “radius” designates a path through this point perpendicular to the axis of rotation of the blade and the term “movement tangent” or “movement vector” designates a straight line through this point perpendicular to the radius. The terms “radius of curvature” and “tangent” correspond to the above-mentioned convention. In a circular blade, the radius and the radius of curvature as well as the movement tangent and the tangent are consequently respectively identical.

It is furthermore known to configure cutting blades for slicing food products, and indeed both circular blades and scythe-like blades, either with a non-toothed blade edge or to provide them with a toothed arrangement. Cutting blades having a toothed arrangement are known from EP 0 548 615 B1 and FR 2 661 634 A1, for example.

It is furthermore known to vary the so-called blade edge angle in the peripheral direction in cutting blades having a non-toothed blade edge. This is, for example, described in DE 10 2007 040 350 A1 in connection with a scythe-like blade. In this respect, a smaller blade edge angle is selected in the dipping region to reduce product compressions on the dipping of the blade. Starting from the dipping region, the blade edge angle can, for example, increase continuously such that the blade edge angle is the largest toward the end of the cutting process. If the smaller blade edge angle is designated as “shallow” in the dipping region, the larger blade edge angle can then be designated as “steep”. An advantageous placement of the cut-off slices can be achieved at a relatively steep blade edge angle since the blade edge can transmit a pulse directed out of the cutting plane to the respective cut-off slice. The peripheral region of the blade knife edge which is effective toward the end of the cutting process and in which a steeper blade edge angle is provided can therefore also be designated as the placement region.

Despite the above-explained known measures and the variety of design possibilities, cutting deficiencies which are serious in part again and again occur in practice at least with some food products. If e.g. the product to be sliced has a rind, a separation of the rind can occur on the cutting. It can furthermore be observed that product slices rip or tear. A cutting off of unwanted wedge-shaped slices can furthermore occur. A further problem occurring in practice is a folding inward or a folding together at least regionally of the product slices. Investigations of the inventors carried out using high-speed cameras during the cutting of boiled ham have, for example, shown that the slices in the upper region, that is where the cutting blade dips into the product, are already prone to an inward folding during the cutting process such that at least some of the cut-off slices are not placed in a flat manner, but are partly folded inwardly at their sides at the front in the transporting-away direction and are consequently oblique as a result. This is unacceptable for the respective operator, in particular when a plurality of product slices sliced after one another should form a stack-like or an overlapping portion from slices disposed above one another. The mentioned cutting deficiencies can result in portions which are not only unappealing, but can in part no longer be properly packaged at all and consequently have to be sorted. In so-called multitrack slicing, that is when a plurality of products disposed next to one another are sliced simultaneously, the mentioned cutting deficiencies possibly do not occur in all the tracks. The above-described problems generally occur both with scythe-like blades and circular blades.

### SUMMARY

It is the object of the invention to provide or to be able to manufacture a cutting blade of the initially named kind, that is in particular a circular blade or scythe-like blade or spiral blade, by which an improved cutting quality can be achieved. A cutting quality which is as uniform as possible should in particular be achieved over the total cutting width of a slicing machine which is usable for products, also called a cutting compartment width.

This object is satisfied by the features of the independent claims.

The invention can generally be used both for scythe-like blades or spiral blades and for circular blades with respect to all independent aspects.

Provision is made in accordance with a first aspect of the invention (claim 1) that each cutting surface extends inclined with respect to a spanned plane perpendicular to the axis of rotation or with respect to a cutting plane and the inclination of the cutting surfaces varies along the peripheral edge. The cutting plane is to be understood as a plane of the cutting blade which can be unambiguously defined by the cutting edges of the cutting teeth forming the blade knife edge. In a preferred embodiment of the invention, in which all the cutting edges or at least a plurality of cutting edges lie in a common plane, this plane is the cutting plane.

Unlike with conventional toothed arrangements, provision is consequently made in accordance with the invention that not all the cutting surfaces of the cutting teeth have the same inclination. Provision is rather made that the cutting surfaces of the cutting teeth have different orientations in a space e.g. with respect to the spanned plane.

The spanned plane can coincide with the cutting plane defined by the edge of the blade. This definition of the spanned plane is, however, not compulsory. That plane which is fixed by the rear side of a base blade body can e.g. also be called the spanned plane. The spanned plane is then spaced apart from the cutting plane (case 1) or the spanned plane coincides with the cutting plane (case 2) in dependence on whether the cutting plane defined by the blade knife edge is spaced apart from the plane fixed by the rear side of the base blade body in the direction of the axis of rotation of the blade (case 1) or not (case 2). In case 1, the spacing between the cutting plane and the plane fixed by the rear side of the base blade body is also called the actual dimension, said spacing being measured in the direction of the axis of rotation and differing from zero. The actual dimension is equal to zero in case 2.

In the embodiment described below in connection with FIG. 3, a blade in accordance with case 1 is assumed in which the cutting plane is spaced apart from the rear side of the base blade body.

The actual position of the spanned plane is not decisive for the present definitions provided with respect to the toothed arrangement in accordance with the invention; it is rather only important that the spanned plane extends perpendicular to the axis of rotation. In the present disclosure, a “plane in parallel with the spanned plane” is therefore mentioned partly as an alternative to the spanned plane.

It has surprisingly been found that much better cutting results, in particular over the total respective available cutting compartment width, can be achieved with such a toothed arrangement than are possible with conventionally toothed cutting blades or with cutting blades without a toothed arrangement. Phenomena such as a tearing or a ripping of the slices as well as a folding inward or together of the slices in particular no longer occur. In addition, it has in particular been found in connection with scythe-like blades that the placement behavior of the cut-off product slices can also be improved.

The direction and the extent of the inclination of the cutting surfaces can generally be selected in dependence on different criteria, in particular in dependence on the properties of the respective food product to be sliced. An adaptation to the positioning of the products to be sliced with respect to the cutting blade or with respect to the axis of rotation of the cutting blade can additionally take place.

In order to geometrically describe the inclination of a cutting surface, the inclination can be described as a superposition of a tilt and an angling. An “angled cutting surface” is here to be understood such that the cutting surface faces in the intended direction of rotation of the blade—in a more or less very pronounced manner, in particular in dependence on the size of the lead angle of the cutting edge, see below.

Alternatively, the inclination of a cutting surface can be defined while including its cutting edge with the aid of a single angle which the cutting surface includes with the cutting plane. The cutting edge then forms the intersection line between the cutting surface and the cutting plane. This requires the cutting edge—in accordance with a preferred embodiment of the invention—to lie in the cutting plane with respect to which the inclination of the cutting surface should be defined. This angle at which the cutting surface therefore extends inclined with respect to the cutting plane will be called the tilt angle KW in the following. This definition forms an independent third aspect of the invention (claim 2) for which protection is also claimed separately.

If the cutting surface inclined by the tilt angle KW with respect to the cutting plane is angled and consequently faces in the intended direction of rotation of the blade, this simultaneously means that the cutting edge of the cutting surface has a lead angle which differs from zero. This lead angle can be defined in different manners and represents an independent aspect (claim 5) of the invention for which protection is also claimed separately.

As already mentioned further above, all of the three above-named independent aspects can be implemented both at a scythe-like blade or spiral blade and at a circular blade.

Provision is made in a preferred embodiment of the invention that each cutting surface is inclined by the tilt angle KW with respect to the cutting plane and the cutting edge of each cutting surface simultaneously has a lead angle, e.g. with respect to the movement tangent at a defined point of the cutting edge, for example at the rear end point of the cutting edge.

Different inclinations of the cutting surfaces can therefore, for example, be achieved in that the tilt angle is varied with an unchanging lead angle or vice versa. It is alternatively possible to vary both angles. The respective resulting inclination of a cutting surface can be selected in dependence on the peripheral position at which the respective cutting tooth is located.

If the inclination of the cutting surfaces therefore varies, either only the tilt angle or only the lead angle can then vary and the respective other angle can be constant, and can indeed be either zero or different from zero. Alternatively, both angles can vary. A plurality of different angle combinations can consequently be implemented along the peripheral edge.

It must be made clear at this point that when an inclination of the cutting surfaces varying along the peripheral edge is mentioned it is not hereby precluded that the cutting surfaces of two or more cutting teeth are identically inclined. In other words, not all of the cutting teeth have to have differently inclined cutting surfaces.

Provision is made in a preferred embodiment that only the tilt angle of the cutting surfaces varies along the peripheral edge, wherein the lead angle of the cutting edges is admittedly constant along the peripheral edge, but differs from zero. Independently of whether the cutting surfaces—viewed in the peripheral direction—overlap or not, the angled cutting edges of the cutting surfaces, that is each having a lead angle differing from zero, can be designated as a stacked or scale-like arrangement which is in particular characterized in that a transition that can generally be designed as desired is present between a respective two cutting surfaces following one another, but which is preferably always characterized in that the two cutting surfaces directly following one another are offset from one another with respect to the axis of rotation in the region of the transition. In other words, a vertical offset or a jump is present on a transition from a cutting surface to a cutting surface of a cutting tooth following directly in the peripheral direction.

Despite this vertical offset or jump, provision is, however, made in a preferred embodiment of the invention that an uninterrupted effective cutting edge lying in the spanned plane or in a plane in parallel with the spanned plane is present which is jointly formed as contiguous by the cutting teeth and the transitions and is also called a continuous blade edge here.

Tests of the inventors have shown that the cutting quality can be considerably increased if at least some of the cutting edges of the cutting surfaces are provided with a lead angle which differs from zero such that a transition which is identifiable as such is present between these cutting surfaces—when, in accordance with the preferred embodiment of the toothed arrangement, the cutting surfaces of cutting teeth directly following one another are each angled.

As already mentioned, an aspect of the invention (claim 5) relates to the orientation of the cutting edges which can generally be described and defined independently of the size and the orientation of the cutting surfaces and also independently of whether the cutting surfaces are planar or curved.

Provision is inter alia made in accordance with this aspect of the invention that at least some cutting edges or each cutting edge includes/include a lead angle, which in particular differs from zero, with a movement tangent, with the movement tangent and the radius intersecting at a point of the respective cutting edge; and/or that at least some cutting edges are respectively oriented such that a front end of the cutting edge viewed in the intended direction of rotation lies on a different radius, preferably a smaller radius, than the rear end of the respective cutting edge; and/or that at least some cutting edges or each cutting edge includes/include a lead angle, which in particular differs from zero, with a connection path, with the connection path connecting the two rear ends or the two front ends of a respective cutting edge and of the directly preceding or following cutting edge to one another.

Due to the lead angle or to the orientation of the cutting edges, it is—in general individually for each cutting edge—possible to determine how a respective cutting edge, e.g. in a reference system having a fixed blade, is oriented and thus at which orientation the respective cutting edge cuts into the respective product to be sliced. For a straight cutting edge lying in a defined plane, a point on the cutting edge is sufficient for an unambiguous definition of its orientation.

Alternatively to a center of the cutting edge selected—randomly in this respect—in the definition with respect to the movement vector, a different point of the cutting edge can also be selected, for example one of the two end points of the cutting edge. The definition of the orientation of the cutting edge with respect to the movement tangent, that is with respect to the movement vector, is also random in principle, but is suitable to the extent that the movement vector of a point on the cutting edge indicates in which direction this point of the cutting edge moves relative to the product at the moment of the cutting into the product.

The absolute value of the angle between the cutting edge and the movement vector of a point on the cutting edge is generally dependent on which point on the cutting edge it is. If absolute values for the lead angle are indicated in the following, they always refer to the point of the respective cutting edge which is at the rear in the direction of rotation—to the extent that the lead angle is defined with respect to the movement vector, i.e. is measured between the movement vector and the cutting edge.

In a scythe-like blade, unlike in a circular blade, it is already provided on the basis of the radius which by definition decreases in the peripheral direction—viewed in the intended direction of rotation—that the front end of each cutting edge viewed in the intended direction of rotation lies on a smaller radius than the rear end of the respective cutting edge. A more pronounced “slanted position” of the cutting edges is, however, preferably provided in accordance with the invention in a scythe-like blade, i.e. the front end preferably lies on a radius which is smaller than the radius on which the front end were to lie if the front end and the rear end were disposed on an imaginary curve which corresponds to the cutting edge of a conventional non-toothed scythe-like blade.

Consequently, the orientation of the cutting edges can alternatively also be defined such that at least some cutting edges or each cutting edge includes/include a lead angle, which in particular differs from zero, with a connection path, with the connection path connecting the two rear ends or the two front ends of a respective cutting edge and of the directly preceding or following cutting edge to one another.

In a scythe-like blade, all the rear ends of the cutting edges and/or all the front ends of the cutting edges can in particular be disposed on a respective imaginary curve which is not a circle and which at least approximately corresponds to the cutting edge of a conventional non-toothed scythe-like blade. The connection paths then together form a polygonal chain which approximates this imaginary curve. The cutting edges of the blade in this respect preferably have a “more pronounced slanted position” than each cutting edge includes an angle with its connection path, which angle differs from zero and will likewise be called a lead angle here. The front end of each cutting edge consequently does not lie on a connection path connecting the two directly adjacent rear ends, but rather lies on a smaller radius.

The value ranges for the lead angle indicated in this disclosure apply both to the definition of said lead angle with respect to the movement vector and to its definition with respect to the connection path. For a given toothed arrangement, the specific value for the size of the lead angle is dependent on its definition, with, however, the difference at least being small or negligible for the cutting blades used in practice at high-speed slicers for slicing food products due to the small length of a cutting edge in comparison with the total length of the peripheral edge of the blade.

A preferred embodiment with which very good cutting results can be achieved will be explained in connection with the drawing in the following. This embodiment relates to a scythe-like blade. Very good cutting results can also be achieved with a circular blade configured in accordance with the invention as tests carried out on different products, including cheese, have shown.

Further advantageous embodiments of the invention which are generally possible for all aspects of the invention and which—if not otherwise stated—can be implemented both at circular blades and at scythe-like blades or spiral blades are also set forth in the dependent claims, in the following description and in the drawing.

With regard to the cutting edge, a lead angle which differs from zero can be in a range from approximately 1° to 10° and can preferably amount to approximately 3° to 6°. Alternatively, the lead angle can be in a range from approximately 10° to 20°. As already mentioned, a preferred embodiment is characterized in that the lead angle is constant for all the cutting surfaces.

Provision is furthermore preferably made that the cutting surfaces are each angled facing in the intended direction of rotation.

The cutting surfaces are preferably each at least substantially planar or curved without edges. Alternatively to planar cutting surfaces, at least slightly curved, e.g. concavely or convexly curved, cutting surfaces are consequently also possible. Such cutting surfaces can, for example, be manufactured by means of a so-called form cutter or by means of a grinding tool. Analog to the geometric definition presented above, a reference, e.g. a reference plane or reference lines with radii of curvature, can also at least approximately be defined for cutting surfaces curved in this manner in order to unambiguously define the inclination of the respective curved cutting surface with respect to the spanned plane or with respect to the cutting plane.

As already mentioned, a further parameter of the toothed arrangement in accordance with the invention is the orientation of the cutting edges of the cutting teeth. Provision is made in accordance with an embodiment that at least some cutting edges or each cutting edge or the projection of at least some cutting edges or of each cutting edge includes/include a lead angle, which in particular differs from zero, with a movement tangent in the spanned plane, with the movement tangent and the radius e.g. intersecting at the rear end point of the respective cutting edge; and/or that at least some cutting edges or each cutting edge includes/include a lead angle, which in particular differs from zero, with a connection path, with the connection path connecting the two rear ends or the two front ends of a respective cutting edge and of the directly preceding or following cutting edge to one another.

The size of the lead angle of a or each cutting edge is generally arbitrary and can be selected in dependence on the properties of the respective food product to be sliced. The lead angle preferably amounts to some few degrees, in particular to not more than approximately 10° and e.g. in a range between 3° to 6°, with larger lead angles, however, generally also being possible.

The cutting edges can each be oriented such that a front end of each cutting edge viewed in the intended direction of rotation lies—with respect to the axis of rotation of the blade—on a different radius, in particular a smaller radius, than the rear end of the respective cutting edge. The extent of each cutting edge between its front end and its rear end can generally be arbitrary, i.e. both an extent in a straight line and an extent which is basically curved in any desired manner are possible.

Provision is made in accordance with a further preferred embodiment that the respective cutting edges of two cutting teeth directly following one another are connected to one another by a transition edge, with the transition edge being configured as a cutting edge.

Not only the cutting edges of the cutting teeth or the cutting edges radially outwardly bounding the cutting surfaces consequently act as the blade edge of the cutting blade in accordance with the invention, but also the transition edges which connect a respective two cutting edges of the cutting teeth directly following one another in the peripheral direction. The cutting behavior of the cutting blade in accordance with the invention can consequently likewise be influenced by the shape or the extent of a transition between two cutting surfaces directly following one another.

Provision is furthermore preferably made that all the cutting edges lie in a common plane, preferably in the spanned plane or in a plane in parallel with the spanned plane; and/or that all the cutting edges and all the transition edges connecting a respective two cutting edges directly following one another jointly form an uninterrupted blade edge which in particular lies in the spanned plane or in a plane in parallel with the spanned plane.

This is, however, not compulsory. The cutting edges can also lie in different planes. Provision can in particular in principle e.g. be made that the cutting edges each intersect the spanned plane or a plane in parallel with the spanned plane. Provision can e.g. also be made that an uninterrupted blade edge jointly formed by all the cutting edges and all the transition edges connecting a respective two cutting edges directly following one another intersects the spanned plane or a plane in parallel with the spanned plane a multiple of times, and indeed alternately coming from the one side and from the other side of this plane, wherein the sections of the blade edge intersecting the plane are either only cutting edges, only transition edges or both cutting edges and transition edges.

The peripheral edge of the blade which acts as a blade edge can be provided with a so-called clearance angle which differs from zero, which will be explained in more detail in the following in connection with FIGS. 5a and 5b. If the clearance angle differs from zero, the cutting edges and the transition edges do not lie in a common plane. A clearance angle of 0° is, however, preferably provided such that in a preferred embodiment all the cutting edges and all the transition edges lie in a common plane, and indeed in the spanned plane or in a plane in parallel with the spanned plane.

Provision is preferably furthermore made that the cutting surfaces each intersect the spanned plane radially outwardly, wherein the intersection lines each form the cutting edge and radially inwardly intersect a slanted surface of the cutting blade which includes an angle with the spanned plane. This angle between the slanted surface and the spanned plane is preferably smaller than the smallest tilt angle of the cutting surfaces such that an imaginary radial extension of the slanted surface would intersect the spanned plane radially outside the cutting edges of the cutting surfaces.

In a further preferred embodiment, the cutting edges and/or transition edges connecting a respective two cutting edges directly following one another are each in a straight line. Alternatively, cutting edges and/or transition edges which are at least slightly curved, e.g. convexly or concavely curved, are also possible. Analog to the geometric definition presented above, a straight line analog to the movement tangent presented above, which allows an unambiguous definition of the orientation of the cutting edge, can also at least approximately be defined for a curved cutting edge.

In accordance with a further embodiment, the respective cutting surfaces of two cutting teeth directly following one another are connected to one another by a transition surface, with the transition surface in particular being formed as a recess projecting backwards with respect to the cutting surfaces.

The recess can be formed as a notch, a channel, a furrow or a groove extending in the radial direction. The recess can form an undercut.

The respective radial extent of two cutting teeth directly following one another is preferably at least substantially the same as the radial extent of the transition surface between the two cutting surfaces. In other words, the cutting surfaces each transition into the transition surface over their total radial extent.

A respective transition edge can be present between the cutting surfaces and the transition surface. These transition edges can respectively be a relatively sharp edge which is not rounded or a rounded edge having a comparatively small radius of curvature. Alternatively, the transition edge can form a comparatively gentle transition and can in particular be rounded with a comparatively large radius of curvature. A wavy surface can hereby be formed overall by the cutting surfaces and transition surfaces. It is also possible to form the two transition edges differently such that the transition from the one cutting surface into the transition surface is formed with comparatively sharp edges and the transition between the other cutting surface and the transition surface extends relatively gently.

The transition surface can be radially outwardly bounded by a transition edge connecting the two cutting edges of the two cutting teeth. As already mentioned above, this transition edge can itself be configured as a cutting edge.

The cross-sectional shape of the transition surface or its profile can generally be formed as desired. The transition surface can in particular generally have any desired extent between the two cutting surfaces. The transition surface preferably has a curved extent, i.e. the cross-sectional shape or the profile of the transition surface is not a straight line. The transition surface is preferably at least approximately curved in a U shape or in a V shape.

The profile of the transition surface is in particular determined by the tool used for the manufacture. A cylindrical cutting tool or a grinding tool having a longitudinal axis inclined with respect to the spanned plane is preferably used such that the transition surface defined by the recess radially outwardly intersects the spanned plane.

Alternatively, a different profile, e.g. a straight-line profile, of the transition surface is also possible, i.e. the transition surface can then e.g. represent the shortest path between the two transition edges into the adjacent cutting surfaces.

The transition surface can, with respect to the size of the adjacent cutting surfaces, adopt a relevant portion of the peripheral angular range. The transition surface can in particular extend over a peripheral angular range which amounts to approximately 0.1 to 0.5 times the peripheral angular range of one of the cutting surfaces.

The transitions between cutting surfaces directly following one another are preferably configured such that the two cutting surfaces directly following one another do not overlap—viewed in the peripheral direction of the axis of rotation.

Provision is furthermore preferably made that the respective cutting edges of two cutting teeth following one another do not overlap and/or do not transition directly into one another viewed in the peripheral direction.

The cutting edges preferably have a constant peripheral length and/or a constant edge length, i.e. all the cutting edges preferably have the same peripheral length.

With regard to the cutting teeth, provision is in particular made that each cutting tooth has a peripheral length and/or a tooth length of approximately 3 mm to 7 mm, preferably of approximately 5 mm.

The term “peripheral length” means the respective extent or expansion of the cutting edges or cutting teeth measured in the peripheral direction, i.e. not the length of the cutting edge or of the cutting tooth measured along the cutting edge. This length is called the edge length or the tooth length in this disclosure.

This distinction takes account of the circumstance that the cutting edges respectively do not lie on a peripheral line of the blade in a geometrically strict sense, in particular due to the inclination of the cutting surfaces and/or due to the lead angle of the cutting edges which may differ from zero. The peripheral length of the cutting edges is consequently smaller than the respective pitch since the pitch is the sum of the peripheral length of the cutting edge and the peripheral length, different from zero, of the transition edge adjacent to the respective cutting edge. In contrast, it is in principle possible for the edge length of a cutting edge to be precisely as large as the pitch or larger than the pitch if the transition edge is relatively small and/or the setting angle of the cutting surface is relatively large.

The pitch of the cutting teeth is preferably constant and in particular amounts to approximately between 3 mm and 6 mm, preferably to approximately 5 mm. The pitch of the cutting teeth is to be understood as the spacing between two cutting teeth directly following one another in the peripheral direction, and indeed measured between mutually corresponding points of the two cutting teeth. With a pitch of 5 mm, for example, the spacing between the two front ends of the cutting edges of the two cutting teeth viewed in the intended direction of rotation thus amounts to 5 mm, for example.

In an alternative embodiment, the pitch of the cutting teeth can vary in the peripheral direction, in particular with respect to the peripheral lengths of the cutting teeth and/or with respect to the peripheral lengths of the transitions between the cutting teeth.

In accordance with the invention, it is not compulsory that the toothed arrangement of the cutting blade is identically designed in each peripheral region, i.e. not all the cutting teeth of the cutting blade are necessarily configured identically, wherein such an embodiment is nevertheless covered by the invention. In addition, it is not absolutely necessary in accordance with the invention for the total effective blade edge of the cutting blade to be provided with a toothed arrangement.

In a preferred embodiment of the cutting blade in accordance with the invention, the total effective blade edge is at least substantially provided with a toothed arrangement which is, however, configured differently in individual peripheral regions.

In accordance with an embodiment, the peripheral edge has at least one peripheral region of type I comprising a plurality of cutting teeth whose cutting surfaces have the same tilt angle.

Provision can furthermore be made that the peripheral edge has at least one peripheral region of type II comprising a plurality of cutting teeth whose cutting surfaces have a varying tilt angle.

Provision can furthermore be made that the peripheral edge has one or more peripheral regions of type I and additionally has one or more peripheral regions of type II.

Provision can be made in a peripheral region of type II that the tilt angle varies from a respective cutting tooth to a directly adjacent cutting tooth or that the tilt angle varies from a respective group of n>1 cutting teeth, following one another and having the same tilt angle with respect to one another, to a directly adjacent group of m>1 cutting teeth, following one another and having the same tilt angle with respect to one another. n=m=2, 3, 4 or 5 in particular applies. In other words, the tilt angle can either vary from tooth to tooth or from tooth group to tooth group in a peripheral region of type II.

Provision is made in a particularly preferred embodiment that the peripheral edge between two peripheral regions of type I comprises a peripheral region of type II in which the value of the tilt angle varies from the tilt angle value of the one peripheral region of type I to the tilt angle value of the other peripheral region of type I.

In particular when the cutting blade is a scythe-like blade or a spiral blade, provision can be made in accordance with a preferred further development that the radius of curvature of the peripheral edge decreases from a maximum radius to a minimum radius viewed in the intended direction of rotation, wherein the value of the tilt angle of the peripheral region of type II decreases from a larger tilt angle value to a smaller tilt angle value viewed in the direction of rotation, in particular in equal angular steps from cutting tooth to cutting tooth.

A blade edge extent which demonstrates both an ideal dipping behavior and an ideal placement behavior can be obtained in this manner by a corresponding tilt position of the individual cutting surfaces along the peripheral edge. A blade edge extent can in particular be reproduced such as is e.g. known from the prior art for scythe-like blades having a non-toothed blade knife edge and in which—as initially mentioned in connection with DE 10 2007 040 350 A1—a comparatively shallow blade edge angle is present in a dipping region and a comparatively steep blade edge angle is present in a placement region.

In the cutting blade in accordance with the invention, the tilt angle of the cutting surfaces of the cutting teeth can accordingly be selected comparatively small in a peripheral region of type I forming the dipping region, whereas the tilt angle of the cutting surfaces can be selected relatively large in a peripheral region of type I forming the placement region. The transition region between the dipping region and the placement region is then formed by the peripheral region of type II in which—viewed from the dipping region—the tilt angle of the cutting surfaces increases starting from the smaller value of the dipping region up to the larger value in the placement region, wherein this increase can take place continuously from cutting tooth to cutting tooth or from cutting tooth group to cutting tooth group at a tilt angle which is constant within a respective group, as has already been generally presented above.

In a possible embodiment of a cutting blade in accordance with the invention, which is configured as a scythe-like blade or as a spiral blade, the placement region approximately extends over a peripheral angular range which is twice as large as the dipping region, with the transition region between the dipping region and the placement region extending over a peripheral angular range which amounts to somewhat more than half the peripheral angular range of the dipping region.

In a further possible embodiment of the cutting blade, the larger tilt angle value of the one peripheral region of type I can be in a range from 20° to 30° and can preferably amount to between 22° and 26°, wherein the smaller tilt angle value of the other peripheral region of type I is in a range from 15° to 22° and preferably amounts to between 17° and 19°, and wherein each angle change in the peripheral region of type II is in a range from 0.2° to 1°, preferably in a range from 0.25° to 0.5°.

In a specific embodiment, the smaller tilt angle value amounts to approximately 18°, wherein either the larger tilt angle value amounts to approximately 26° and each angular step amounts to approximately 0.5° or the larger tilt angle value amounts to approximately 22° and each angle change amounts to approximately 0.25°.

In a cutting blade in accordance with the invention configured as a circular blade, the inclination or the tilt angle of the cutting surfaces can also either be constant over the total peripheral edge or vary along the peripheral edge. With a varying tilt angle, a plurality of peripheral regions can be provided of which at least two peripheral regions differ with respect to the value of the tilt angle which is constant within the respective peripheral region, or with respect to the change behavior of the tilt angle within the respective peripheral region, or differ in that the tilt angle is constant in the one peripheral region and the tilt angle varies in the other peripheral region.

The tilt angle can thus e.g. vary in a “wave-like” manner and can alternately increase and decrease from peripheral region to peripheral region and, for example, “oscillate” between a minimum of e.g. 18° and a maximum of e.g. 22° or 26°. The “gradient” can e.g. be 0.25° or 0.5° per cutting tooth, i.e. the tilt angle can vary in equal angular steps from cutting tooth to cutting tooth.

A variation of the tilt angle over the peripheral edge of the circular blade is preferably symmetrical since the peripheral region with which the circular blade impacts a product to be sliced will not be predetermined in practice in a circular blade—unlike in a scythe-like blade—due to the superposition of the rotation about the axis of rotation and the revolving movement about the axis extending in parallel with the axis of rotation. The total periphery of 360° can thus e.g. be a whole-number multiple of a period of the “tilt angle oscillation” in the case of the above-mentioned “wave-like” variation of the tilt angle.

It has already been mentioned a multiple of times that surprisingly good cutting results can be achieved with a cutting blade in accordance with the invention. A clear reduction up to an elimination of the so-called inward folding effect or folding-together effect in the cut-off product slices could in particular be observed for critical products such as boiled ham.

An improvement in the quality of the cut-off product slices can be achieved overall by the invention. This increases the product yield and reduces manual reworking at the cut-off slices or at the portions formed therefrom. This in turn reduces downtimes at a packaging machine connected downstream of the slicing apparatus.

A particular advantage of the cutting blade in accordance with the invention comprises the fact that the improved cutting quality simultaneously allows an increase in the cutting speed.

The individual machining of the cutting teeth in accordance with the invention and in particular the individual configuration of the cutting surfaces allow the implementation of a variety of designs of a toothed arrangement of the blade. The cutting blades can hereby be directly adapted to specific product properties. An adaptation can additionally take place with respect to the cutting geometry. In particular in the manufacture of the toothed arrangement with respect to the applications for which the cutting blade is designed, it is possible to take account of the manner in which the blade penetrates into the product, and indeed while taking account of the position of the product in the slicing apparatus, in particular in a so-called cutting compartment, and while taking account of the size of the cutting region provided overall, in particular of the cutting compartment width.

Such adaptation possibilities are in particular of importance for a so-called multitrack slicing, that is for a simultaneous slicing of a plurality of products disposed next to one another. With a multi-track slicing, the products are supplied to the cutting plane defined by the blade knife edge simultaneously at least substantially at a right angle to said cutting plane.

### BRIEF DESCRIPTION OF THE DRAWINGS

The invention will be described in the following by way of example with reference to the drawing. There are shown:

FIG. 1 a plan view along the axis of rotation of a possible embodiment of a cutting blade in accordance with the invention;

FIG. 2 an enlarged view of a part of the toothed arrangement of the cutting blade of FIG. 1;

FIG. 3 different views of a cutting blade in accordance with the invention with enlarged detailed views for explaining the embodiment of the toothed arrangement of the blade;

FIG. 4 an enlarged detail of a toothed arrangement in accordance with the invention for explaining the geometry of the toothed arrangement; and

FIGS. 5a and 5b representations for explaining the clearance angle.

### DETAILED DESCRIPTION

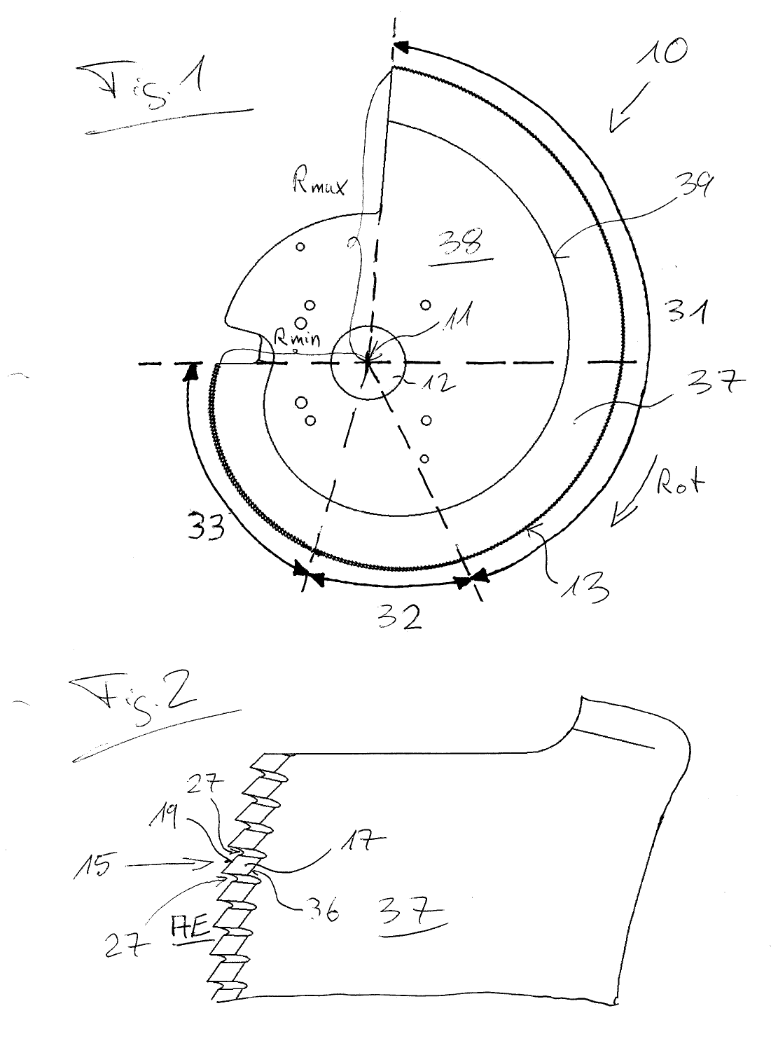

The embodiment shown in FIG. 1 of a cutting blade in accordance with the invention for a high-speed slicer for slicing food products, such as is generally known to the skilled person, is a scythe-like blade which rotates about an axis of rotation 11 in an intended direction of rotation Rot during a cutting operation.

The radially outer peripheral edge 13 of the cutting blade 10 which acts as a blade edge extends approximately over a peripheral angular range of almost 270°, and indeed from a minimum radius Rmin up to a maximum radius Rmax.

In a slicing operation, a dipping region 33 of the rotating blade 10 dips into the respective product to be sliced, said dipping region, for example, extending over a peripheral angular range of 74° and having a peripheral length of approximately 317 mm. The dipping region 33 is adjoined by a transition region 32 which, for example, extends over a peripheral angular range of 41° and has a peripheral length of approximately 205 mm. This transition region 32 of the peripheral edge 13 is adjoined by a placement region 31 of the blade knife edge which extends over a peripheral angular range of approximately 150° and has a peripheral length of approximately 917 mm.

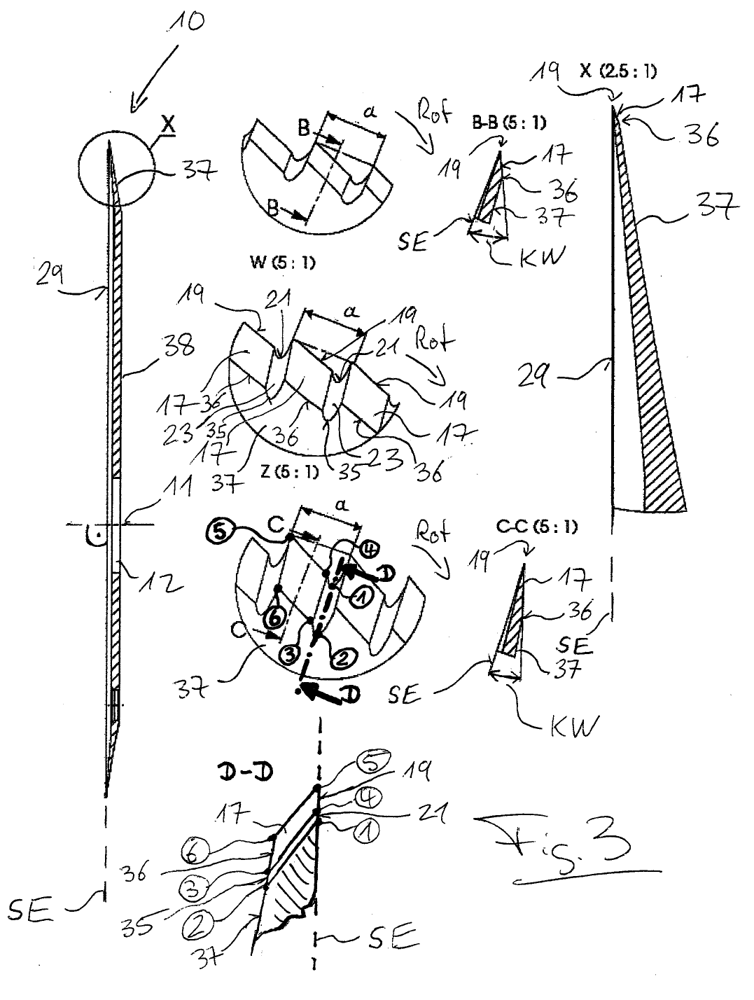

The blade knife edge having these three regions 31, 32 and 33 is provided with a toothed arrangement in accordance with the invention which will be looked at in more detail in the following. Each cutting tooth of the toothed arrangement inter alia has a cutting surface 17 (cf. FIG. 2) which faces toward the front side of the blade 10 and which has a specific inclination. The three regions 31, 32, 33 differ from one another with respect to the inclination of the cutting surfaces 17. This will be explained in more detail in the following.

FIG. 1 is a plan view of the front side of the blade 10 which, during the cutting operation, is remote from the respective product to be sliced or from the respective products to be sliced simultaneously. The axis of rotation 11 extends centrally through a circular reception opening 12 of the blade 10 by means of which the blade 10 can be attached to a blade holder of the slicing apparatus not shown here. The blade holder e.g. comprises a rotor hub of a high-speed slicer such as is generally known to the skilled person.

An end face 38 which is planar in this embodiment and extends perpendicular to the axis of rotation 11 adjoins the reception opening 12.

As the representations at the far left and at the far right in FIG. 3 also show, a slanted surface 37, from which the individual cutting surfaces 17 of the cutting teeth 15 (FIG. 2) extend radially outwardly, radially outwardly adjoins the end face 38. The tilt angle of the slanted surface 37, that is the angle between the slanted surface 37 and a spanned plane AE (cf. FIG. 3), is smaller than the smallest tilt angle provided at the cutting surfaces 17. In other words, the slanted surface 37 extends flatter than each cutting surface 17 such that an imaginary radial extension of the slanted surface 37 would intersect the spanned plane AE radially outside the peripheral edge 13 (FIG. 1).

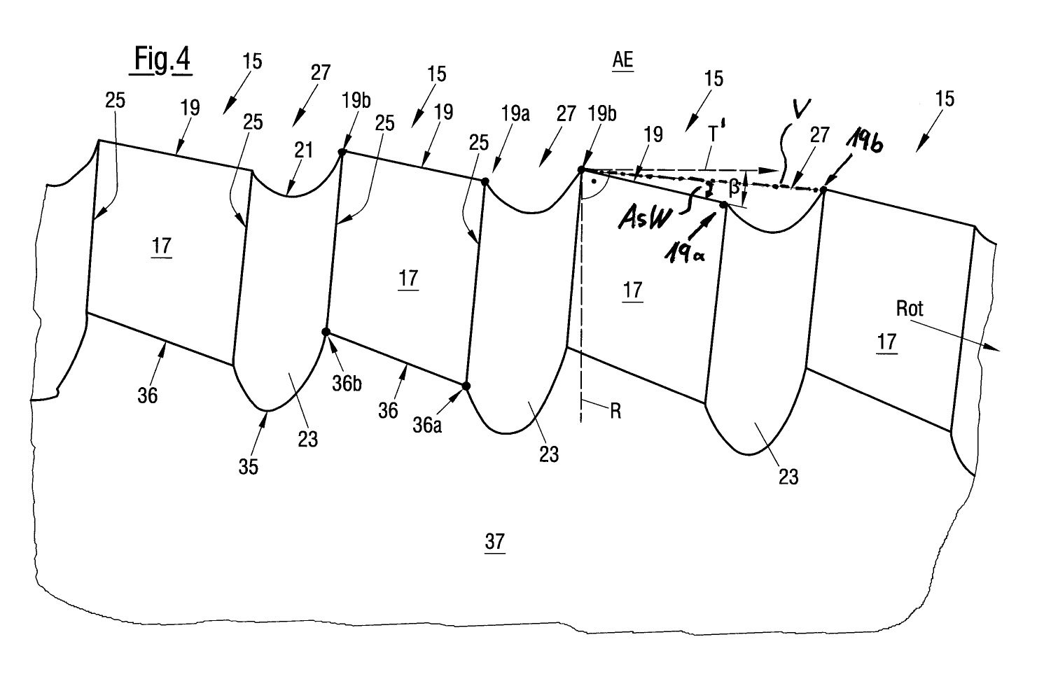

FIG. 2 is a detail of FIG. 1, shown in enlarged form, in the dipping region 33 which shows the first nine cutting teeth 15 of the toothed arrangement at the top, starting from a minimum radius Rmin of the blade 10. As FIG. 2 shows, the cutting surfaces 17 are radially outwardly bounded by a respective cutting edge 19. Transitions 27 between the cutting teeth 15 formed as recesses are likewise radially outwardly bounded by a cutting edge 21 (FIG. 3) which connects a respective two cutting edges 19 of the cutting surfaces 17. It can furthermore be recognized in FIG. 2 that the transition from the slanted surface 37 into the cutting surfaces 17 of the cutting teeth 15 is formed by a respective straight inner edge 36 from whose end points a respective edge extends to the corresponding end point of the respective cutting edge 19. These edges 25 (FIG. 4) therefore each extend between the slanted surface 37 and the spanned plane AE. The inner edges 36 can respectively be configured as having sharp edges or as rounded.

As FIG. 1 shows, a transition edge 39 is also formed between the planar end face 38 and the slanted surface 37. The edge 39 can be configured as sharp or as rounded.

The geometry in accordance with the invention of the cutting teeth 15, in particular of the cutting surfaces 17 and of the transitions 27, will be explained in more detail in the following in connection with FIGS. 3 and 4.

In FIG. 3, the top middle representation with the section B-B shows an enlarged detail of the toothed arrangement of the blade 10 of FIG. 1 in the placement region 31. The representation beneath it shows an enlargement of the toothed arrangement in the transition region 32, whereas the representation disposed thereunder with the section C-C shows an enlargement of the toothed arrangement in the dipping region 33. The intended direction of rotation Rot of the blade 10 is indicated by a respective arrow. The cutting surfaces 17 are therefore not only tilted, i.e. connect the respective inner edge 36 disposed in the slanted surface 37 above the spanned plane AE to the spanned plane AE, but are also angled facing in the direction of rotation Rot.

In the embodiment of FIG. 3, the cutting surfaces 17 of the cutting teeth 15 are both tilted and angled in all three peripheral regions 31, 32 and 33 of the toothed arrangement of the blade.

With regard to the tilt angle KW, it can thus be seen from FIG. 3 that the tilt angle KW is comparatively large in the placement region 31 (top middle representation in FIG. 3). The tilt angle KW preferably amounts to 26° here. The tilt angle KW is smaller in the dipping region 33 (second-last middle representation in FIG. 3) than in the dipping region 31. The tilt angle KW preferably amounts to 18° here.

The cutting surfaces 17 consequently extend flatter or less steeply in the dipping region 33 than in the placement region 31. As already initially explained, compressions of the product can hereby in particular be avoided on the dipping of the blade 10, whereas an improved placement of the respective cut-off product slice can be achieved at the end of the cutting process due to the steeper cutting surfaces 17 in the placement region 31.

In the transition region 32, of which an exemplary detail is shown in the second middle representation of FIG. 3, the cutting surfaces 17 are tilted such that a respective three cutting surfaces 17 following one another have the same tilt angle KW. The tilt angle KW in this respect decreases by 0.5°, starting from the value 26°, in the transition region 32 from a respective group of three to a directly following group of three, wherein the last group of three before the dipping region 33 has a tilt angle KW of 18.5° and the cutting teeth 15 of the dipping region 33 then each adjoin it at a tilt angle KW of the cutting surface 17 of 18°.

In an alternative embodiment, the tilt angle value in the dipping region 33 can in turn amount to 18°, whereas the tilt angle value in the placement region 31 amounts to 22° and each angular step between directly consecutive groups of three of cutting teeth 15 in the transition region 32 has a value of 0.25°.

The pitch a of the toothed arrangement is constant over the total peripheral region and amounts to 5 mm in this embodiment. Alternatively, the pitch of the toothed arrangement can vary as has already been shown in the introductory part.

Due to the angling of the cutting surfaces 17, cutting surfaces 17 directly following one another do not lie in a common plane and cutting surfaces 17 directly following one another do not transition directly into one another.

In the embodiment shown here, a transition 27 is present between a respective two cutting surfaces 17 directly following one another and is formed as a recess having a U-shaped cross-section and extending in the radial direction.

Each transition 27 (cf. also FIG. 4) comprises a transition surface 23 which transitions radially inwardly over a transition edge 35 into the slanted surface 37 and which is radially outwardly bounded by a transition edge 21 which lies in the cutting plane SE.

A special feature of this embodiment now comprises that these transition edges 21 connect the cutting edges 19 of the adjacent cutting surfaces 17 and are themselves configured as cutting edges. All the cutting edges 19 and all the transition edges 21 connecting a respective two cutting edges 19 directly following one another hereby jointly form a continuous, uninterrupted total cutting edge.

A further special feature in this embodiment comprises that this uninterrupted cutting edge jointly formed by the cutting edges 19 and the transition edges 21 lies in the cutting plane SE in a continuous manner. This is illustrated by the last two middle representations in FIG. 3, wherein the last bottommost middle representation schematically shows a section D-D perpendicular to the cutting plane SE through the chain-dotted line of the representation disposed above it.

The chain-dotted line extends through the bottommost point of the transition surface 23. The points 1 and 2 are the points of intersection of the chain-dotted line with the cutting plane SE (point 1) or with the slanted surface 37 (point 2). The points 3 and 4 are the points of intersection of a first transition edge 25 with the cutting plane SE (point 4) or with the slanted surface 37 (point 3), whereas the points 5 and 6 are the points of intersection of a second transition edge 25 with the cutting plane SE (point 5) or with the slanted surface 37 (point 6). The two transition edges 25, the cutting edge 19 and the inner edge 36 span the respective cutting surface 17 which is planar in this example, that is does not have a curved extent of any kind.

As can be seen from the sectional representation, the points 1, 4 and 5 as well as the cutting edge 19 connecting the points 5 and 4 and the transition edge 21 connecting the points 4 and 1 lie in the cutting plane SE, whereas the points 2, 3 and 6 as well as the inner edge 36 connecting the points 6 and 3 and the transition edge 35 connecting the points 3 and 2 lie in the slanted surface 37.

In this respect, the points 6 and 3—measured in the radial direction—are differently far away from the axis of rotation 11, wherein the point 6 is disposed radially further outward than the point 3 and—since the slanted surface 37 extends inclined with respect to the cutting plane SE—is therefore located closer to the cutting plane SE than the point 3, i.e. the point 6 is disposed lower than the point 3. The point 2 is in turn disposed radially further inward than the point 3 and is consequently higher than the point 3 and higher than the point 6.

Accordingly, the point 1 is disposed radially further inward than the point 4 which is in turn disposed radially further inward than the point 5. All three points 1, 4 and 5 are, however, located at the same level since they lie in the common cutting plane SE.

Furthermore, the specific lengths and relative positions of the edges 19, 25, 36 of the respective cutting surface 17 that connect the points 3, 4, 5 and 6 are selected in this embodiment such that the cutting surface 17 is not only tilted, but is also angled, and indeed such that the cutting surface 17 faces in the direction of rotation Rot.

It can also be seen from FIG. 4 that the cutting surfaces 17 are each angled in the embodiment shown such that the cutting surfaces 17 face in the intended direction of rotation Rot.

Due to the angling of the cutting surfaces 17, a vertical offset or a jump between a respective two cutting surfaces 17 directly following one another in the region of the respective transition 27 results radially inside the cutting edges 19, 21 in the peripheral direction.

In the embodiment shown here, the four corner points 19a, 19b, 36a and 36b lie in a common plane, namely in the plane of the planar cutting surface 17. A planar cutting surface 17 is, however, not compulsory. The cutting surface 17 can also be concave or curved in the same relative arrangement of the named corner points. Provision can also be made that not all of the named corner points lie in a common plane. The cutting surface 17 is then correspondingly curved.

FIG. 4 shows, purely by way of example, the possibilities of unambiguously defining the orientation of the cutting surface 17 in a reference system having a fixed blade.

In FIG. 4 the end 19b of the cutting edge 19 which is at the rear viewed in the intended direction of rotation Rot forms the reference point. The movement tangent T′ at the rear end 19b is perpendicular to the radius R through the rear end 19b and is identical to the movement vector of the rear end 19b. The cutting edge 19 is inclined by an angle β with respect to this movement vector T′, and indeed such that the cutting edge 19 faces in the direction of rotation Rot.

A further alternative possibility for defining the “slanted position” of the cutting edges 19 and thus of the lead angle AsW is likewise shown in FIG. 4.

As mentioned in the introductory part, the lead angle AsW can be defined as the angle between a cutting edge 19 and e.g. that connection path V (chain-dotted in FIG. 4) which connects the rear end 19b of the respective cutting edge 19 and the rear end 19b of the cutting edge 19 which is directly adjacent in the intended direction of rotation Rot to one another.

As likewise mentioned in the introduction, all of these connection paths V together form a polygonal chain which approximates an imaginary constant curve which is not a circle and on which all the rear ends 19b of the cutting edges 19 are disposed and which at least approximately corresponds to the cutting edge of a conventional non-toothed scythe-like blade. The front end 19a of each cutting edge does not lie on the respective connection path V in this embodiment, but rather on a smaller radius, i.e. closer to the axis of rotation of the blade than each point on the connection path V. The cutting edge can, however, also lie on the connection line V.

It is generally also possible for the cutting surfaces 17 to each comprise a plurality of individual surfaces which are respectively planar and/or curved, for example convexly or concavely curved. The cutting surfaces 17 can in particular have edged or rounded transitions between the individual surfaces. When they are curved, the cutting surfaces 17 are, however, preferably a respective portion of a surface which is regular or differentiable in a mathematical sense and consequently do not have any edges.

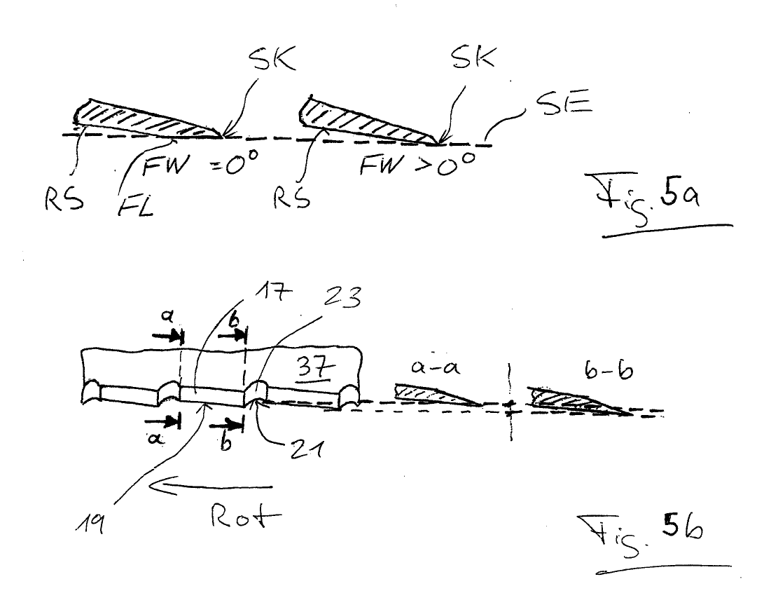

FIG. 5a shows the definition of the so-called clearance angle FW in a respective section perpendicular to the cutting plane SE defined by the cutting edge SK and in parallel with the axis of rotation, not shown, for the example of conventional blades. In the left representation, FW=0°, i.e., at the rear side RS of the blade, a surface FL adjacent to the cutting edge SK lies in the cutting plane SE. In contrast, the right representation shows a blade having a clearance angle FW which differs from zero.

It can be seen from FIG. 5b that the cutting edges 19 and the transition edges 21 (and thus the points 1, 4 and 5 in accordance with FIG. 3) no longer lie in a common plane with a blade in accordance with the invention and a clearance angle FW differing from zero. The right representation shows the two sections a-a and b-b in accordance with the left representation.

The invention comprises both blades with FW=0 and with FW≠0°, wherein FW=0 is the preferred embodiment.

What is claimed:

1. A cutting blade for an apparatus for slicing food products, the cutting blade rotating about an axis of rotation during a cutting operation,
having a radially outer peripheral edge which acts as a blade edge and which has a curved extent about the axis of rotation; and
having a plurality of cutting teeth which are arranged distributed following one another along the peripheral edge,
wherein each cutting tooth has a blade edge which comprises a cutting surface and a cutting edge radially outwardly bounding the cutting surface; and
wherein each cutting surface extends inclined with respect to a spanned plane perpendicular to the axis of rotation or with respect to a cutting plane and the inclination of the cutting surfaces varies along the peripheral edge.

2. A cutting blade for an apparatus for slicing food products, the cutting blade rotating about an axis of rotation during a cutting operation,
having a radially outer peripheral edge which acts as a blade edge and which has a curved extent about the axis of rotation; and
having a plurality of cutting teeth which are arranged distributed following one another along the peripheral edge,
wherein each cutting tooth has a blade edge which comprises a cutting surface and a cutting edge radially outwardly bounding the cutting surface;
wherein the cutting edges lie in a common cutting plane; and
wherein the cutting surfaces each extend inclined with respect to the cutting plane and intersect the cutting plane at a tilt angle, with the cutting edges forming the respective intersection line between the cutting surface and the cutting plane.

3. A cutting blade in accordance with claim 2,
wherein the cutting edges are each oriented such that the cutting surfaces are each angled facing in the intended direction of rotation.

4. A cutting blade in accordance with claim 2,
wherein the tilt angle of the cutting surfaces along the peripheral edge is constant; and/or
wherein the tilt angle is in a range from approximately 15° to 30°.

5. A cutting blade for an apparatus for slicing food products, the cutting blade rotating about an axis of rotation during a cutting operation,
having a radially outer peripheral edge which acts as a blade edge and which has a curved extent about the axis of rotation; and
having a plurality of cutting teeth which are arranged distributed following one another along the peripheral edge,
wherein each cutting tooth has a blade edge which comprises a cutting surface and a cutting edge radially outwardly bounding the cutting surface;
wherein at least some cutting edges or each cutting edge includes/include a lead angle with a movement tangent in a cutting plane, with the movement tangent and the radius intersecting at a rear end point of the respective cutting edge;
and/or wherein at least some cutting edges are respectively oriented such that a front end of the cutting edge viewed in the intended direction of rotation lies on a smaller radius than the rear end of the respective cutting edge;
and/or wherein at least some cutting edges or each cutting edge includes/include a lead angle with a connection path, with the connection path connecting the two rear ends or the two front ends of a respective cutting edge and of the directly preceding or following cutting edge to one another.

6. A cutting blade in accordance with claim 2,
wherein the cutting surfaces are each angled facing in the intended direction of rotation.

7. A cutting blade in accordance with claim 2,
wherein the cutting surfaces are each at least substantially planar or extend in a curved manner without edges.

8. A cutting blade in accordance with claim 2,
wherein at least some cutting edges or each cutting edge includes/include a lead angle with a movement tangent in the cutting plane, with the movement tangent and the radius intersecting at a rear end point of the respective cutting edge;
and/or wherein at least some cutting edges or each cutting edge includes/include a lead angle with a connection path, with the connection path connecting the two rear ends or the two front ends of the respective cutting edge and of the directly preceding or following cutting edge to one another.

9. A cutting blade in accordance with claim 2,
wherein the angle of the first cut of the cutting edges is constant along the peripheral edge and differs from zero.

10. A cutting blade in accordance with claim 2,
wherein all the cutting edges lie in a common plane; and/or in that all the cutting edges and all the transition edges connecting a respective two cutting edges directly following one another jointly form an uninterrupted blade edge.

11. A cutting blade in accordance with claim 2,
wherein the cutting edges and/or transition edges connecting a respective two cutting edges directly following one another are each in a straight line.

12. A cutting blade in accordance with claim 2,
wherein at least some cutting edges are respectively oriented such that a front end of the cutting edge viewed in the intended direction of rotation lies on a smaller radius than the rear end of the respective cutting edge.

13. A cutting blade in accordance with claim 2,
wherein the respective cutting edges of two cutting teeth directly following one another are connected to one another by a transition edge, with the transition edge being configured as a cutting edge.

14. A cutting blade in accordance with claim 2,
wherein the respective cutting surfaces of two cutting teeth directly following one another are connected to one another by a transition surface.

15. A cutting blade in accordance with claim 14,
wherein the transition surface is formed as a recess projecting backwards with respect to the cutting surfaces, the recess being formed as a notch, a channel, a furrow or a groove extending in the radial direction; and/or wherein the recess forms an undercut.

16. A cutting blade in accordance with claim 14,
wherein the cutting surfaces transition into the transition surface over their total radial extent.

17. A cutting blade in accordance with claim 14,
wherein a respective transition edge is present between the cutting surfaces and the transition surface.

18. A cutting blade in accordance with claim 14,
wherein the transition surface is radially outwardly bounded by a transition edge connecting the two cutting edges of the cutting teeth.

19. A cutting blade in accordance with claim 14,
wherein the transition surface in cross-section has an extent between the two cutting surfaces.

20. A cutting blade in accordance with claim 14,
wherein the transition surface extends over a peripheral angular range which amounts to approximately 0.1 to 0.5 times the peripheral angular range of one of the cutting surfaces.

21. A cutting blade in accordance with claim 2,
wherein the cutting edges have a constant peripheral length and/or a constant edge length.

22. A cutting blade in accordance with claim 2,
wherein each cutting tooth has a peripheral length and/or a tooth length of approximately 3 mm to 7 mm.

23. A cutting blade in accordance with claim 2,
wherein the pitch of the cutting teeth is constant; or
wherein the pitch of the cutting teeth varies in the peripheral direction.

24. A cutting blade in accordance with claim 2,
wherein the peripheral edge has at least one peripheral region of type I comprising a plurality of cutting teeth whose cutting surfaces have the same tilt angle.

25. A cutting blade in accordance with claim 2,
wherein the peripheral edge has at least one peripheral region of type II comprising a plurality of cutting teeth whose cutting surfaces have a varying tilt angle.

26. A cutting blade in accordance with claim 25,
wherein the tilt angle varies from a respective cutting tooth to a directly adjacent cutting tooth; or in that the tilt angle varies from a respective group of n>1 cutting teeth following one another and having the same tilt angle with respect to one another, to a directly adjacent group of m>1 cutting teeth following one another and having the same tilt angle with respect to one another.

27. A cutting blade in accordance with claim 25,
wherein the peripheral edge between two peripheral regions of type I comprises a peripheral region of type II in which the value of the tilt angle varies from the tilt angle value of the one peripheral region of type I to the tilt angle value of the other peripheral region of type I.

28. A cutting blade in accordance with claim 2,
wherein the cutting blade is a circular blade; wherein the tilt angle of the cutting surfaces is either constant over the total peripheral edge or varies along the peripheral edge; and
wherein a plurality of peripheral regions are provided of which at least two peripheral regions differ with respect to the value of the tilt angle which is constant within the respective peripheral region, or with respect to the change behavior of the tilt angle within the respective peripheral region, or differ in that the tilt angle is constant in the one peripheral region and the tilt angle varies in the other peripheral region.

29. A cutting blade in accordance with claim 25,
wherein the cutting blade is a scythe-like blade or a spiral blade; wherein the radius of curvature of the peripheral edge decreases from a maximum radius to a minimum radius viewed in the intended direction of rotation; and wherein the value of the tilt angle of the peripheral region of type II decreases from a larger tilt angle value to a smaller tilt angle value viewed in the direction of rotation.

30. A cutting blade in accordance with claim 29,
wherein the larger tilt angle value of the one peripheral region of type I is in a range from 20° to 30° and the smaller tilt angle value of the other peripheral region of type I is in a range from 15° to 22°, wherein each angular step is in a range from 0.2° to 1°.

31. A cutting blade in accordance with claim 29,
wherein the smaller tilt angle value amounts to approximately 18°; and wherein either the larger tilt angle value amounts to approximately 26° and each angular step amounts to approximately 0.5° or the larger tilt angle value amounts to approximately 22° and each angular step amounts to approximately 0.25°.
